(19) United States
(12) Patent Application Publication
(10) Pub. No.: US 2025/0153898 A1
(43) Pub. Date: May 15, 2025

(54) CONTAINER LID AND RELATED DRYING METHODS

(71) Applicants: CHEP UK LIMITED, Surrey (GB); CABKA SPAIN S.L.U., Valencia (ES); CHEP ESPAÑA SA, Madrid (ES)

(72) Inventors: Luis ASENSIO COTILLAS, Valencia (ES); Daniel LOPEZ URAN, London (GB); Alfonso BAZ Y BAZ, Madrid (ES)

(21) Appl. No.: 18/840,265

(22) PCT Filed: Feb. 22, 2023
(86) PCT No.: PCT/GB2023/050398

§ 371 Date: Aug. 21, 2024

(30) Foreign Application Priority Data
Feb. 22, 2022 (GB) 2202440.0

(51) Int. Cl. B65D 19/38; B65D 19/18; F26B 5/08

(52) U.S. Cl. CPC B65D 19/38; B65D 19/18; F26B 5/08; B65D 2519/00208; B65D 2519/00273; B65D 2519/00333; B65D 2519/00537; B65D 2519/008; B65D 2519/009

(57) ABSTRACT

There is disclosed a lid (107) for containers for transporting dry goods, the lid comprising water guides (200) disposed on an underside (111) thereof. These water guides (200) are configured to guide water centrifugally and to then discharge said water from the lid during rotation of the lid around an axis (2) substantially perpendicular to the lid, whether the lid is spun on its own or as part of a container assembly (100) including a collapsed container body (104). The lid, and any such container assemblies, can therefore be efficiently dried using spin driers, using the centrifugal forced so generated. This brings about considerable energy savings over, for example, blow drying techniques.

### TECHNICAL FIELD

The present invention relates to a lid for containers for the transportation of dry goods, and to related containers, container assemblies and drying methods.

### BACKGROUND

Containers for transporting dry goods across distribution networks are well known. These goods may include dry ingredients, components, packaging materials, packaged products and/or bulk goods. These containers are often described as freight containers or transportation containers. In one example, a container may have a total volume, i.e. a volumetric capacity, of around 700 litres, but a variety of sizes and geometries are otherwise available. For example, these containers may each have a volume of anywhere up to between around 1000 litres and around 1500 litres. The container body is usually sized to correspond to the footprint of the base, which usually corresponds to that of a standard pallet.

A type of such containers can be referred to as “Foldable Large Containers”, or “FLCs”. Typically, FLCs comprise relatively rigid, individually collapsible and erectable side panels (these are alternatively called “walls”).

Another type of such containers is commonly referred to as “Sleeve Pack Containers”, or “SPCs”. Typically, SPCs comprise a relatively flexible side sleeve, which is also collapsible and erectable, but as a whole.

FLCs and SPCs are particularly beneficial when pooled (i.e., when used as reusable containers), because they improve the efficiency and thus the cost effectiveness of reverse logistics in the supply chain. In addition to the side panels and/or sleeve, FLCs and SPCs generally also comprise a base and a removable lid. It is when the lid is removed that the body (i.e. the side panels and/or sleeves) may be conveniently collapsed, or folded, on the base of these containers. The lid is then usually recovered and placed over the collapsed container. In this way, an empty, folded container assembly is prepared for transportation back to a service centre, after use. It will be understood that in the context of the present application, the wording “container assembly” refers to a collapsed or folded container, for example of the FLC or SPC type, with the folded or collapsed body of the container arranged within the corresponding base, with the lid covering said base and folded body, and any shelves that may be provided with the container (for a short description of which, read further below).

In the assembled state, the base, body and lid of the containers define an enclosed space in which contents may be stored. One or more removable shelves may be provided to divide up the enclosed space in, for example, two or more compartments. This may allow for a more efficient use of the enclosed space, during transportation of the goods. Once the goods have been offloaded, however, the shelves are removed, just like the lid, and placed in the folded container assembly for return to the service centre, so that a new pooling cycle for the container may begin.

The new pooling cycle usually starts with washing and drying the container parts in the service centres. Whilst some washing and drying may be carried out on the container assemblies as a whole, at some stage the parts forming the container assemblies are washed and dried individually to meet or exceed prescribed conditions required by the end users. Further, the drying of these individual parts is usually carried out by blowing hot air and this can be particularly inefficient. Only suitably washed and dried, folded container assemblies can be forwarded on, from the service centres, to the locations of use, where the containers are first erected, then filled with the goods to be transported, and finally dispatched. Improving the washing and/or drying efficiency at the service centres is therefore important. It is desirable to improve profit margin and process sustainability, and/or to lower costs, while continuing to ensure end-user satisfaction.

The container lids are particularly problematic, since their undersides typically present various water-retaining features, such as any cavities formed by reinforcement ribs and the like. So that the reconditioning of containers such as FLCs and SPCs at the service centres may be carried out more efficiently and sustainably, described herein are container lids and associated techniques which enable improved drying at the service centres. This improves the efficiency of the whole reconditioning chain.

### SUMMARY OF THE INVENTION

According to an aspect of the present disclosure, there is provided a lid for containers for transporting dry goods, the lid comprising water guides provided on an underside thereof, said water guides being configured to guide water centrifugally and to discharge said water from the lid during rotation of the lid around an axis substantially perpendicular to the lid. In this way, water that could otherwise remain entrapped in or on the lid, or by the lid in a container assembly as described herein, over which the lid is placed, can be conveniently reduced or eliminated.

The lid underside may comprise one or more radially extending ribs. It will be appreciated that radially extending ribs are particularly effective in displacing water centrifugally. The ribs may extend from a centre of the rib underside, or other location on the lid underside, to a periphery of the lid underside, or in any event to a relatively more peripherical location on the lid underside.

Alternatively or additionally, it is possible to provide one or more radially extending ribs irradiating from a point or from points offset from the centre of the lid underside. Any of these arrangements would enhance the water displacement process by centrifugal forces. In particular, it may be advantageous to dispose one or more ribs in a herringbone configuration. In case at least two herringbones of radially disposed ribs are provided, these could be arranged symmetrically around an axis of symmetry of the lid.

On a notional “x-y” plane over which the lid extends, it will be understood that said offset may be in any “x” and/or “y” directions, independently. The axis of rotation, therefore, may generally extend in the “out-of-plane” or “z” direction, in the context of such a reference system.

It is generally not necessary that the rotation axis be through the centre of the lid (although this may be advantageous), nor that other rotation components according to the x or y axes be completely absent (although, again, this may be advantageous). It will generally be advantageous though, if the rotation axis passes through the centre of gravity of the lid, or the container assembly. To facilitate this, it may be possible to place one or more inserts, such as a frame, in the container assembly, to retain in a predetermined position the folded container body, or to place one or more counterweights on the lid, or on the container assembly, or on the rotor over which the lid and/or the container assembly are disposed for spin-drying.

At least one rib may branch out from any other one of the ribs. Ramifications of ribs may be particularly advantageous with a view to maximising the number and extension of the ribs, and, therefore, of the water guides for guiding the water centrifugally during rotation of the lid.

At least a subset of ribs may each comprise a (first) rib segment, or rib length, that extends, preferably perpendicularly, from a bottom surface portion of the lid underside (as seen when facing the lid underside). Relatively tall ribs generally prove particularly effective in draining water centrifugally, as they provide more surface on which the water may be guided.

At least a subset of ribs may each comprising a (second) rib segment, or rib length, that extends, preferably perpendicularly, from a raised surface portion of the lid underside (as seen when facing the lid underside). Relatively shorter ribs may too sufficiently contribute to appropriate water drainage, especially if provided on said raised surface portions of the lid underside, because these parts of the lid underside are relatively less prone to water accumulation or retention.

It will be understood that one or both of said bottom and raised surface portions may be planar. “Planar” is used herein to mean that the corresponding feature develops on a flat plane, or generally flat plane, i.e. extending on or over said x-y notional plane of the lid, or another flat plane. Accordingly, said surface portions may be generally parallel, but not co-planar.

Any bottom surface portions of the lid underside may correspond to a generally raised surface portion of the lid's over-side, or outer side (the underside of the lid also representing the lid's inner side).

Conversely, any raised surface portion on the lid underside may correspond to a bottom surface portion on the lid's over-side.

Of course, other configurations may be possible, for example when the cross-sectional thickness of the lid is not the same or not generally uniform across the lid's extension. It is preferable, however, if the lid is made of a polymeric material, that the lid has a generally uniform cross-sectional thickness, for ease of manufacturing, for example by injection moulding.

More specifically, any raised surface portions on the lid underside, which correspond to any bottom surface portions on the lid outer side, may correspond to container stacking features for stacking containers on top of each other when fully erected, or when folded. In a preferred configuration, such zones correspond to the conventional pallet skids. Other configurations are however possible.

The radially extending ribs may comprise at least a subset of ribs each comprising a maximum rib height measured at said first segment, and a minimum rib height measured at said second rib segment.

Said maximum and minimum rib heights may correspond to a same level measured from the lid's bottom surface portion. In this way, the taller and shorter ribs reach and terminate on a notional lid inner top plane, which may preferably be parallel to the lid's bottom or raised surface portions.

It will be understood that with the term “rib” we describe herein a single length of ridged material, or protrusion, which extends linearly along a single direction from a point of origin to a point of termination, said points defining said direction and, therefore, said rib. Bifurcations, ramifications or ribs changing direction and extending along a new line, will generally count as different ribs.

In preferred embodiments, the water guides may comprise one or more sloping surface portions defined by the lid underside.

The sloping surface portions may preferably be planar, such as being provided as an inclined plane, or concavely curved on the lid underside, that is, facing the lid underside, with a concavity directed upwards.

At least one of said sloping surface portions may be located peripherally.

Additionally, or alternatively, at least one sloping surface portion may be provided inside a dimple or other small recess, or concavity, provided on the lid underside. In this way, it may be easier to drain any water accumulated or entrapped by such dimple, small recess or concavity, during rotation of the lid.

Said dimples or other small recesses or cavities on the lid underside may correspond to one or more projections on the lid over-side and such projections may constitute one or more retaining features for stacking containers, or container assemblies one over the other, such that any stacked container, or container assembly, may be firmly retained in place over another container, or container assembly.

In more preferred embodiments, said sloping surface portions may have an inclination that goes from a lower level corresponding to a bottom of the lid underside, to an upper level measured at an edge of the lid underside, to direct water towards said edge during rotation. Optionally, this upper level substantially corresponds to the aforementioned raised level measured at the raised surface portions of the lid underside.

In very preferred embodiments, there is cooperation between the one or more ribs described herein, and the one or more sloping surface portions described herein, to move water centrifugally towards at least a periphery of the lid underside. Accordingly, water may be displaced centrifugally from one or more ribs to one of said sloping surfaces, and water from said sloping surface(s) may then centrifugally reach said periphery. However, this does not preclude water from centrifugally reaching said periphery along at least one of the ribs alone.

In very preferred embodiments, the water guides comprise one or more drainage channels for discharging the water from the lid during rotation of the lid around the axis.

At least one of said one or more drainage channels may be located at or near a border of the lid, and optionally at or near a corner of the lid, where centrifugal forces are maximised by the rotation of the lid.

Where the lid geometrically defines one or more corners (for example, where the lid has a generally square or rectangular shape), each drainage channel may advantageously be located at or near a respective corner of the lid, given that such corners may represent the locations further distanced from the rotation axis, therefore at which the centrifugal forces are maximum on the lid.

To favour water discharge, at least one drainage channel may extend away from the lid border, optionally perpendicularly therefrom, or, preferably, with an outward slant.

To favour water flow, and/or so as to accept as much incoming water as possible, at least one drainage channel may have a substantially U-shaped fluidic cross section.

The lid may have a substantially rectangular shape, as is common in the relevant sectors.

The lid may comprise an outer skirt provided around the lid, as is also common in the relevant sectors. The one or more aforementioned channels may conveniently be defined on said skirt, internally thereof.

The lid may be made of a substantially rigid plastics, as is also common in the relevant sectors.

The lid may be provided as a single, injection-moulded piece, as is also common in the relevant sectors.

The lid may be adapted to conform with interference to an erected container body, or to a container base adapted to receive a collapsed container body, such that the lid may be retained firmly, yet removably, on said container body or base. Such interference fit may result particularly problematic, in that water may be retained during rotation of a container assembly covered with such a lid at the interference location, that is where the lid exchanges forces with the container base. It may be particularly advantageous to provide the aforementioned channels at such locations.

According to another aspect of the present disclosure, there is provided a container assembly comprising a container base, a collapsed container body disposed on said container base and a container lid as described herein, wherein the container lid may be disposed over said container base and collapsed body.

According to another aspect of the present disclosure, there is provided a container comprising a container base, an erected container body disposed on said container base and a container lid as described herein, wherein the container lid is disposed on said erected container body.

Of course, the container body may comprise one or more relatively rigid side panels, as is the case for FLCs. Alternatively, however, the container body may comprise one or more relatively flexible side sleeves, as is the case for SPCs.

The container and the container assembly may have a footprint which is sized according to a standard pallet footprint (more particularly, it will be the base of the container to be so shaped and sized).

According to another aspect of the present disclosure, there is provided a method of drying a lid as described herein, or a container assembly as described herein, the method comprising spinning the container lid or the container assembly around the rotation axis.

The method may comprise disposing the lid with the lid underside facing down.

The method may also comprise retaining the container body inside the container assemblies using one or more retainers, such as a frame or the like.

The method may also comprise balancing a rotor of a spin dryer prior to rotation.

Specific embodiments of the present invention will now be described, purely by way of example, with reference to the accompanying drawings in which:

### BRIEF DESCRIPTION OF THE DRAWINGS

FIG. 1 is a front perspective view of an FLC comprising a removable lid as described herein;

FIG. 2 is a front perspective view of an SPC comprising another removable lid as described herein;

FIG. 3 is a front perspective view of the removable lid of FIG. 2;

FIG. 4 illustrates a method of collapsing, or folding, an FLC comprising the removable lid of the container of FIG. 2, into a container assembly ready for transportation;

FIG. 5 is a front perspective of a container assembly as described herein;

FIG. 6 is a spin dryer for container assemblies (and/or container lids) as described herein;

FIG. 7 shows the container assembly of FIG. 5 being loaded into the spin dryer of FIG. 6;

FIG. 8 is a front perspective view of yet another removable lid for containers as described herein; and,

FIG. 9 is a magnified view of a part of the removable lid of FIG. 8, showing possible water extraction paths.

### SPECIFIC DESCRIPTION

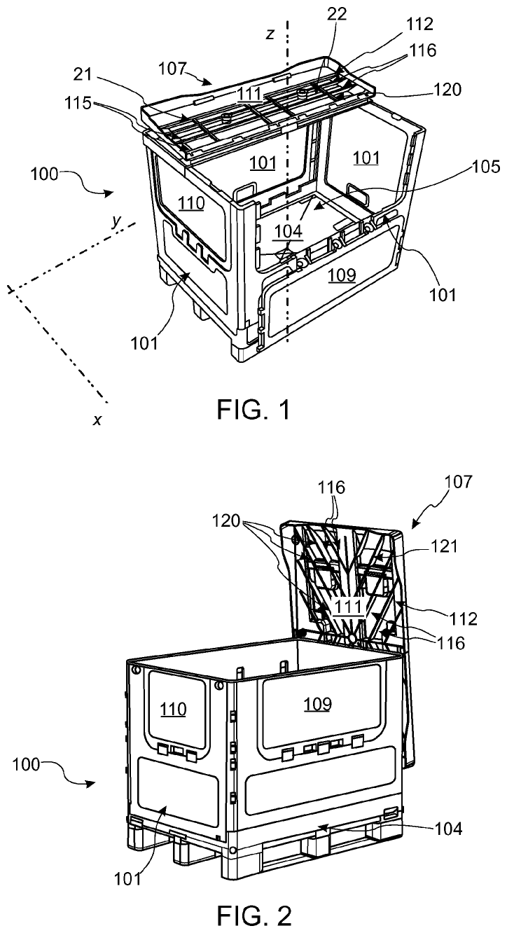

FIG. 1 shows a rigid container 100 for the transportation of dry goods in accordance with the present disclosure. This container falls in the category of FLCs described above. The general shape and configuration of this rigid container 100 will now be described. The rigid container 100 defines an enclosed space 105 in which goods to be transported can be stored. The enclosed space 105 is delimited laterally by one or more container walls or side panels 101, at the bottom by a container base 104, and at the top by a removable container cap or lid 107, which may be foldable in halves longitudinally, as shown in FIG. 1, to facilitate access to the goods. The lid 107, however, is usually provided as a single part.

The front wall 101 incorporates an openable front door 109, which may be opened to facilitate access to the goods (or any shelves that may be provided inside the container 100, which may support these goods). One of the side walls 101 incorporates an openable side door 110, which can be used similarly to the front door 109. One or more removable shelves (not shown) can be disposed within the container 100 so as to divide up the enclosed space 105 in two or more compartments respectively. The focus of the present specification is, however, on the lid 107. Lids 107 of this type are generally rectangular, and usually made by injection moulding as a single piece from a polymeric material such as a plastics.

FIG. 1 shows a lid 107 according to the present disclosure. Reinforcing ribs 20 are visible on the folded half of the lid 107 that reveals the lid underside 111. These reinforcing ribs 20 are disposed to form a grid 21 on the lid underside 111, as conventional. Whilst these ribs 20 are not radial ribs as intended in the present specification, and therefore do not provide water-guiding performance as intended in the present specification, it should be noted that the lid underside 111 shows sloping surface portions 115 disposed at a periphery 112 of the lid underside 111. These sloping surface portions 115 each constitute a first described example of water guide 200 as described herein. Water guides 200 which are provided on the lid underside 111 and are configured to guide water (not shown) centrifugally and to discharge said water from the lid 107 during rotation of the lid 107 around an axis substantially perpendicular to the lid 107 are the focus of this specification. The rotation axis is shown in FIG. 1, and labelled z. In this way, after washing the lid 107, water that could otherwise have remained entrapped in the lid underside 111, for example in a receptacle 22 defined by the grid 21 on the lid underside 111, or on for example any of the side walls 101, when folded, by any one of the ribs 20 provided on the lid underside 111, can be conveniently reduced or eliminated by rotating the lid around the axis z.

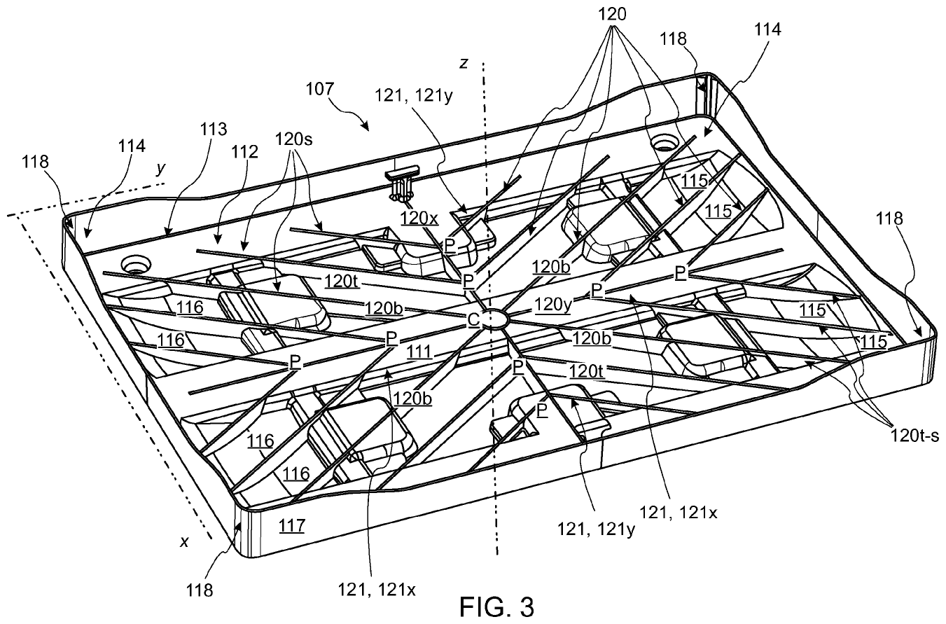

FIG. 2 shows an SPC-type container 100 with another lid 107 as described herein. The container body 101 is in this instance provided in the form of a flexible sleeve, as known. The lid 107 comprises a set of radially extending ribs 120. While these radially extending ribs 120 still provide the lid 107 with the required reinforcement (in the sense if increasing the bending stiffness of the lid 107), they are also effective in acting as water guides 200 for displacing water centrifugally, when the lid 107 is rotated around the rotation axis z, which passes through its centre C. The rotation axis z is shown in FIG. 1, while the centre C is shown in FIG. 3, which reproduces the lid 107 of FIG. 2 in isolation from the container 100.

In the case of the lid 107 of FIGS. 2 and 3, there are eight radially extending ribs 120 that extend from the centre C of the lid 107 and lid underside 111. Four ribs 120x, 120y extend from the centre C in opposite directions along notional axes x and y (these coordinates are shown in FIGS. 1 and 3) and divide the lid underside 111 in four respective quadrants.

Of the four ribs 120x, 120y that define the four quadrants on the rectangular lids of FIGS. 2 and 3, those extending along the y axis are relatively short, in that is their height 120s is shorter compared to the maximum height 120t of the other ribs 120x. In addition, four more ribs 120b also extend from the centre C of the lid underside 111, generally bisecting each quadrant.

Additional radially extending ribs 120 irradiate from points P which are offset from the centre C of the lid underside 111, with an offset in this case which is either according to direction denoted by the axis x or y (but in alternative arrangements, these points P could have an offset according to both axes x and y). As a result, in each quadrant of the lid underside 111, in this particular configuration we have a total of five outwardly diagonally extending ribs 120, as denoted by the reference numeral 120 at the top right of FIG. 3, and by the corresponding leading lines. In total, therefore, this lid 107 comprises 24 radially extending ribs, which form a network of ribs 120 which facilitate water extraction by rotation of the lid around the axis z.

The described network of radially extending ribs 120 is, more particularly, herringbone-shaped, when halves of the lid 107 are considered, whether determined according to the axis x or y. Each half of the lid underside 111 so determined includes one herringbone 121 of radially extending ribs 120. Two herringbones 121x are arranged symmetrically with respect to a x axis passing through the centre C. Two herringbones 121y are arranged symmetrically with respect to a y axis passing through the centre C. The herringbones 121x, 121y so formed by the described radially extending ribs 120 are also shown in FIG. 3. These arrangements enhance the water displacement process by centrifugal forces.

In all the configurations described so far, the rotation axis z is defined as passing through the centre C of the lid 107. However, this is not a strict requirement, as the rotation axis could be offset from the centre C, and for example coincide with any of the points P described above. Rotation components according to the x or y axes could be completely absent, although again this is not a strict requirement. It is generally advantageous, however, as known in the arts, to have the rotation axis z pass through the centre of gravity of the lid 107, or of the container assembly 100, if it is the container assembly 100 as a whole that is spun, rather than the lid 107 in isolation. To enable this, the skilled person would now recognise that it will be possible to place one or more inserts, such as a frame, any wedges or other retainers in the container assembly 100, to retain in a predetermined position the folded container body 101—so that the centre of gravity of the container assembly 100 will likely not change during rotation, or to place one or more counterweights on the lid 107, or on the container assembly 100, or on the rotor over which the lid and/or the container assembly 107, 110 are disposed for spin-drying—to balance the load prior to rotation.

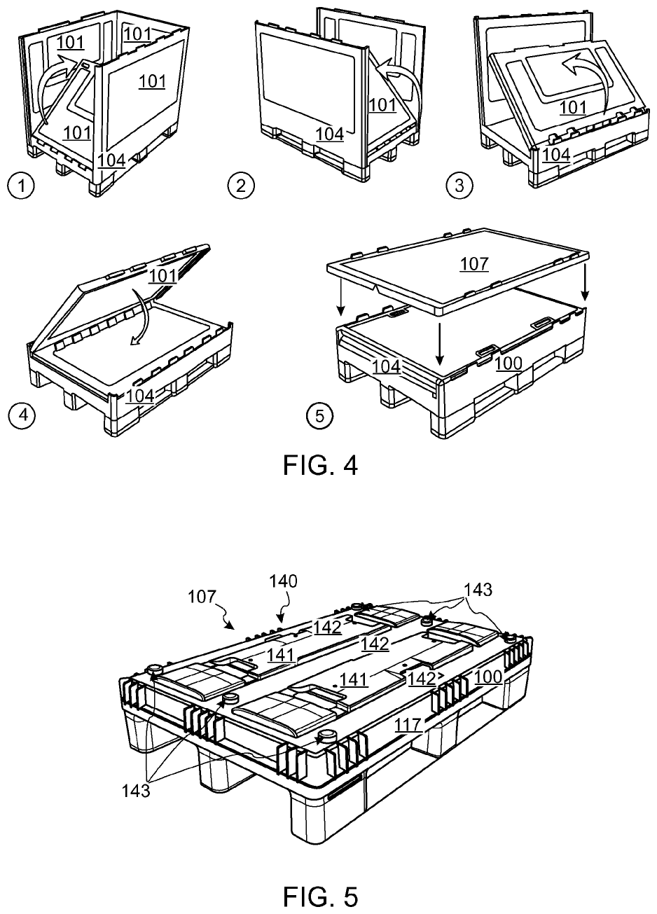

FIG. 4, and particularly FIGS. 4-1 to 4-4, illustrate schematically a method of preparing for reverse logistics the foldable rigid container 100 of FIG. 1, using a lid 107 as shown in FIG. 2. The container 100 is folded, in this example, by folding in turn the side walls 101 (FIGS. 4-1 an 4-2) one on the other, and both over the base 104 of the container 100, then by folding the front and back walls 101 over said side walls 101, as shown in FIGS. 4-3 an 4-4. All the walls are hinged, but the details of these hinges (as well as the hinge of the lid 107) are not within the scope of the present specification. Alternatively, the walls 101 may be collapsible in different fashion, for example by removing each of the walls 101 or all of the walls 101 collectively altogether from the base 104 of the container 100 and lying them flat over this base 104.

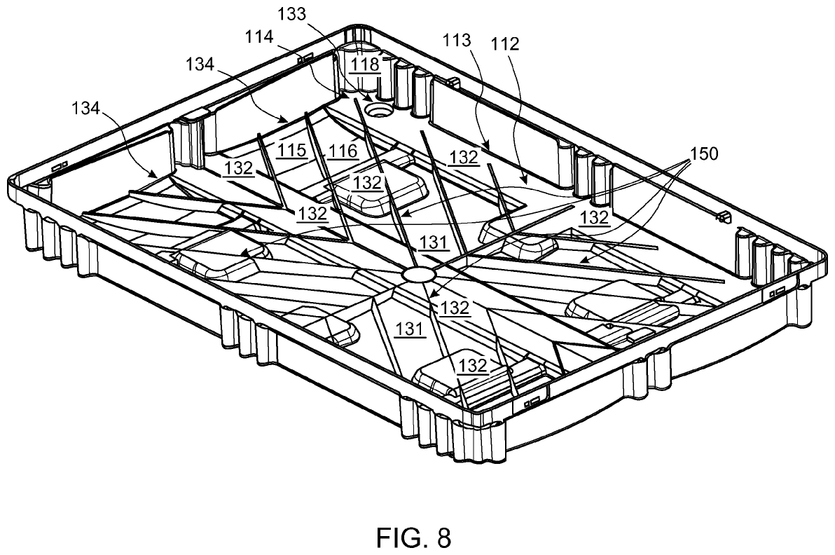

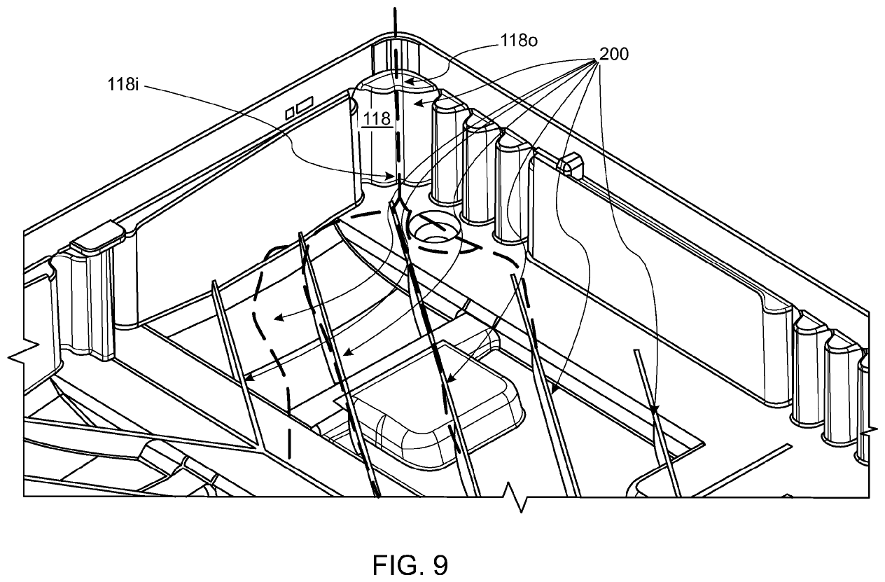

With continued reference to the lid 107 of FIGS. 2 and 3, and now with additional reference to the similar lid shown in FIGS. 8 and 9 (this is a slightly different lid 107 which, however, has all the key features described in connection with the lid 107 of FIGS. 2 and 3), it will be appreciated that most ribs 120 comprise one or more first rib segments 120t (or rib lengths 120t) that extends perpendicularly from a bottom surface portion 131 (for clarity, only labelled in FIG. 8) of the lid underside 111. Instead, all the radially extending ribs 120 comprise one or more second rib segments 120s (or rib length 120s), that extends perpendicularly from a raised surface portion 132 (also for clarity only labelled in FIG. 8) of the lid underside 111. The two ribs 120y extending along the y axis are only short, in that they do not include segments or lengths of the first type described above, that is having a relative higher projection. These ribs 120y, therefore, offer an example of ribs 120 having uniform height along their extension, which is a possibility. Depending on the design of the lid 107, it would be possible to have ribs 120 having uniform height according to the height of the first segments 120t described above.

In the present context, the word “planar” means flat, or substantially flat. For example, something will be planar if it generally extends over the notional x-y plane shown in FIGS. 1 and 3. The bottom surface portions 131 and the raised surface portions 132 described herein above and labelled in FIG. 8 are generally parallel, that is are disposed on parallel planes, but not co-planar. Further, the bottom surface portions 131 of the lid underside 111 correspond to a generally raised surface portion 141 of the lid's over-side 140 (i.e. the lid's outer side, in use). Conversely, the raised surface portions 132 on the lid underside 111 correspond to a bottom surface portion 142 on the lid's over-side 140. The lid over-side 140 is shown in FIG. 5.

Other configurations are possible, for example in connection with a non-uniform cross-sectional thickness of the lid. It will be appreciated that the presently described lids 107 are cross-sectionally generally uniform, but this may not be the case in alternative designs. More particularly, it will be observed that the raised surface portions 132 on the lid underside 111 not only correspond to the bottom surface portions 142 on the lid outer side 140, but they additionally correspond to container stacking zones for stacking containers 100 on top of each other when fully erected, or when folded to form a container assembly 100. In a preferred configuration, such as the one presently described and shown in FIG. 5, these zones match the footprint of a conventional pallet skids.

With continued reference to FIGS. 2, 3, 8 and 9, the taller and shorter ribs 120 reach and terminate on a notional lid inner top plane 150 which is preferably parallel to the lid's bottom and raised surface portions 131, 132. Ribs 120 terminating on this notional plane 150 are labelled in FIG. 8.

The one or more radially extending ribs 120, during spinning, act as one or more corresponding water guides 200 to guide water centrifugally outwardly. In the described lid, at least some of these ribs 120 guide the water toward one or more sloping surface portions 115 of the lid underside 111 which, in turn, facilitate the displacement of the water toward the periphery 112 of the lid underside 111, and, from there towards the edge 113 of the lid underside 111.

Note that, additionally or alternatively, at least one sloping surface portion 115 may be provided inside a dimple or any other small recess or concavity 133 provided on the lid underside 111. These dimples or small recesses 133 are labelled in FIGS. 8 and 9. In this way, it may be easier to drain any water accumulated or entrapped by such small recesses or concavities 133, during rotation of the lid 107.

The recesses 133 labelled in FIGS. 8 and 9 correspond to one or more projections 143 on the lid over-side 140. Such projections 140 constitute one or more retaining features for stacking the containers 100, or container assemblies 100, over one another. In this way, the stacked containers 100, or container assemblies 100, can be firmly retained in place. Returning, however, to the peripheral sloping surface portions 115, said sloping surface portions 115 have an inclination that goes from a lower level generally corresponding to a bottom 131 of the lid underside 111, to an upper level 134 measured at the border 113 of the lid underside 111, to direct water towards said border 113 during rotation. In the presently described lid 107, this level 134 substantially corresponds to the aforementioned raised level measured at the raised surface portions 132 of the lid underside 111, but other arrangements differing in this detail are possible.

The cooperation between the one or more radially extending ribs 120 described herein and the one or more sloping surface portions 115 described herein efficiently moves the water centrifugally towards the periphery 112 of the lid underside 111, and towards the border 113 of the id underside 111. From there, the water tends to accumulate during rotation in one of the corners 114 of the lid 107, which normally are the points of maximum distance from the centre C of the lid 107.

Accordingly, the lids 107 shown in FIGS. 2, 3, 8 and 9 also comprise further water-guiding features 200 in the form of one or more drainage channels 118 arranged to discharge the water from the lid 107 during rotation of the lid 107 around the rotation axis z. Each drainage channel 118 extends away from the lid's border 113, with a slight outward slant. In the described lids 107, the drainage channels 118 have a substantially U-shaped fluidic cross section, and are formed, in particular, on a skirt 117 that wraps around the lid 107 and the lid underside 111. Each channel 118 has an inlet 118i in fluidic connection with the corresponding corner 114 of the lid underside 111. Each channel also has a fluidic outlet 1180 that discharges water during rotation from the lid's skirt 117.

Importantly, the lids described herein are adapted to conform with a soft snap-fit to the erected container body 101, or to the container base 104 adapted to receive the collapsed container body 101, such that the lid may be retained firmly, yet removably, on said container body or base 101, 104. Such interference fit may retain water during centrifugal action, since at these locations there is no clearance for the water to drain out of the container assemblies. Advantageously, therefore, the channels 118 described herein are formed at locations when the lid 107 may be fitted with interference to the container body or base, 101, 104. The lid's corners 114 may or may not be the only locations where the lid snaps to the container body or base 101, 104.

FIG. 9 shows a detail of the lid underside 111 of FIG. 8. In particular, FIG. 9 shows a cumulative water draining benefit reached by providing multiple, useful water guides 200 on the lid underside 111 as described herein. Water may be displaced radially along the radially extending ribs 120. Water may also be displaced outwardly from any recesses 133 or concavities 116 as directed by the action of the sloping surface portions 115. Any water situated at the periphery 112 or border 113 of the lid underside 111 may be moved by centrifugal action towards the drainage channels 118 located at the corners 114 of the lid underside 111.

The drainage channels 118, which in the described lids are usefully formed on the lid's skirt 117, more specifically on the inner side of the skirt 117, extend generally perpendicularly from the lid underside 111, but with a slight outward slant. Water from the periphery 112 and border or edge 113 of the lid underside 111 enters laterally into the channel 118 via the channel inlet 118i located on the underside 111 of the lid and is then moved by centrifugal action along the channel 118, before being discharged from the channel outlet 1180, provided distally from the lid underside 111, on the lid's skirt 117. It will be understood, however, that the provision of one or more drainage channels 118 as one of the water guiding features 200 described herein is in principle independent from the presence of such skirt 117. Also, it can be appreciated that, given that the water is moved centrifugally, the channel 118 has aptly been designed with said generally U-shaped fluidic cross section having an opening accessible by water incoming from the inside of the lid 107, or of the folded container assembly 110.

In FIG. 9, the dashed lines all represent possible drainage paths of water that may come into contact with the lid underside 111. Said paths are first defined along any of the radially extending ribs 120 and sloping surface portions 115. FIG. 9 also shows a path through one of the recesses 133 described above. Both of these features, that is the radially extending ribs 120 and the sloping surface portions, encourage and facilitate displacement of water towards the periphery 112, and, more particularly, in the described lid 107, towards the border 113 and corner 114 of the lid underside 111, during rotation. Eventually, these paths merge, in the described lid 107, at the corners 114 thereof, and all contribute to the water received, during rotation, by the channel 118, and discharged therefrom.

Collectively, therefore, the radially extending ribs 120, the sloping surface portions 115 and the channels 118 realise a set of water guides 200 provided on the lid underside 111, which are arranged to encourage and favour the displacement and then the discharge of excess water during spin drying of the lid 107.

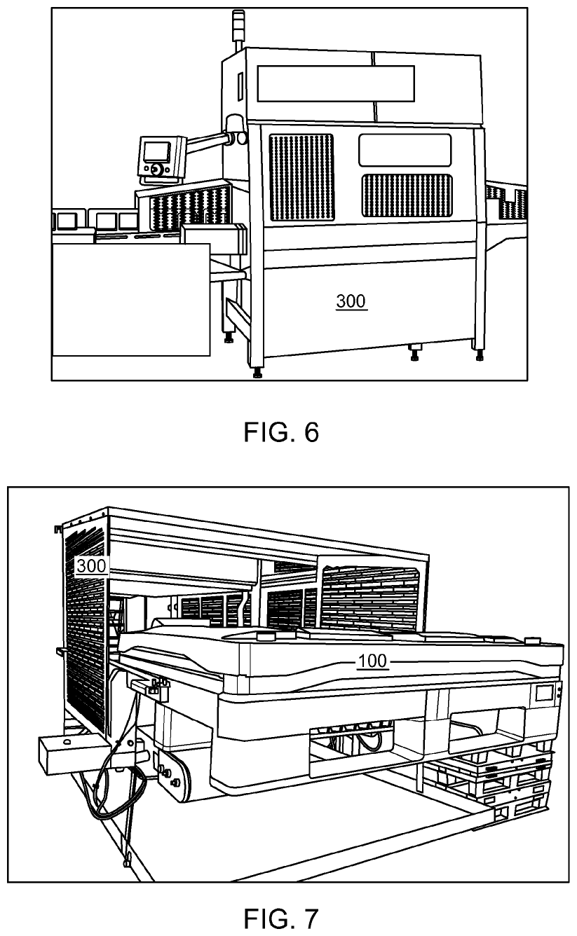

Efficient spin drying of lids 107 and containers 100 according to the presently proposed designs has been successfully tested in commercial spin dryers 300, an example of which is shown in FIG. 6.

A method of drying a lid 107 as described herein, or a container assembly 100 as described herein, consists in spinning the container lid 107 and/or the container assembly 100 around the rotation axis z, after loading the spin dryer 300 as shown in FIG. 7.

The containers had previously been washed used a predetermined amount of water in the region of a few litres, at a controlled temperature. The spin dryer was operated at angular speeds generally in the order of tens of cycles per minute, which generated on the container (and any water retained in it) centrifugal forces produced by centrifugal accelerations lower than the gravitational acceleration g. Remnant water and/or moisture was detected by weighing the containers using adequately sensitive scales.

### LIST OF REFERENCE SIGNS

20 Ribs (prior art)
21 Grid
22 Receptacle (prior art)
100 Container (erected) or container assembly (folded)
101 Container wall
104 Container base
105 Enclosed space of container
107 Container cap or lid
109 Front door of container
110 Side door of container
111 Lid underside
112 Periphery of lid underside
113 Border of lid underside
114 Corner
115 Sloping surface portion
116 Drained cavity on lid underside
117 Skirt
118 Channel
118i Channel inlet
1180 Channel outlet
120 Radially extending ribs (i.e, particularly configured for water extraction)
120x Ribs extending along x axis
120y Ribs extending along y axis
120b Ribs bisecting a lid quadrant
120t Tall segment of rib
120s Short segment of rib
120t-s Variable-height segment of rib
121 Herringbone
121x Herringbone with x symmetry
121y Herringbone with y symmetry
131 Bottom surface portion of lid underside
132 Raised surface portion of lid underside
133 Recess on lid underside
134 Level reached by sloping surface portions at border of lid underside
140 Lid's outer side (or over-side)
141 Raised portions of lid outer side
142 Bottom portions of lid outer side
143 Projection on lid outer side
150 Notional plane on which ribs terminate
200 Water guides
300 Spin dryer machine
z Rotation axis
x First planar coordinate
y Second planar coordinate
C Centre of lid
P Points from where ribs irradiate

1. A lid for a container for transporting dry goods, the lid comprising water guides provided on an underside thereof, said water guides being configured to guide water centrifugally and to discharge said water from the lid during rotation of the lid around an axis substantially perpendicular to the lid.

2. The lid of claim 1, wherein said water guides comprise one or more radially extending ribs.

3. The lid of claim 2, wherein said one or more radially extending ribs comprise at least one rib extending from a centre of the lid underside.

4. The lid of claim 2, wherein said one or more radially extending ribs comprise at least one rib extending from a point offset from a (or the) centre of the lid underside;
optionally, wherein said at least one rib branches out from said at least one rib extending from the centre of the lid underside.

5. The lid of claim 2, wherein said radially extending ribs comprise at least a subset of ribs each comprising a (first) rib segment, or rib length, that extends, preferably perpendicularly, from a bottom surface portion of the lid underside.

6. The lid of claim 2, wherein said radially extending ribs comprise at least a subset of ribs each comprising a (second) rib segment, or rib length, that extends, preferably perpendicularly, from a raised surface portion of the lid underside;
optionally, wherein one or both of said bottom and raised surface portions are planar.

7. The lid of claim 5, wherein said radially extending ribs comprise at least a subset of ribs each comprising a maximum rib height measured at said first segment, and a minimum rib height measured at said second rib segment.

8. The lid of claim 1, wherein said water guides comprise one or more sloping surface portions defined by the lid underside.

9. The lid of claim 8, wherein said sloping surface portions are planar, or concavely curved.

10. The lid of claim 8, wherein at least one of said sloping surface portions is located peripherally;
optionally, wherein at least one of said sloping surface portions is provided inside a dimple or other small recess, or concavity, provided on the lid underside.

11. The lid of claim 8, wherein said sloping surface portions slope from a lower level corresponding to a bottom of the lid underside, to an upper level measured at an edge of the lid underside;
optionally, wherein upper level substantially corresponds to a raised level measured at said raised surface portion(s).

12. The lid of claim 1, wherein said water guides comprise one or more drainage channels for discharging said water from the lid during rotation of the lid around said axis.

13. The lid of claim 12, wherein at least one of said one or more drainage channels is located at or near a border of the lid, optionally at or near a corner of the lid;
optionally, wherein each drainage channel is located at or near a respective corner of the lid.

14. The lid of claim 12, wherein at least one of said one or more drainage channels extends away from said lid border, optionally perpendicularly therefrom, or, preferably, with an outward slant.

15. The lid of claim 12, wherein at least one of said one or more drainage channels has a substantially U-shaped transversal cross section.

16. The lid of claim 1, wherein the lid has a substantially rectangular shape.

17. The lid of claim 1, wherein the lid comprises an outer skirt provided around the lid.

18. The lid of claim 1, wherein the lid is made of a substantially rigid plastics.

19. The lid of claim 1, wherein the lid is provided as a single, injection-moulded piece.

20. The lid of claim 1, wherein the lid is adapted to conform with interference to an erected container body, or to a container base adapted to receive a collapsed container body, such that the lid is retained firmly, yet removably, on said container body or base;
optionally, wherein said container body comprises one or more relatively rigid side panels;
alternatively, wherein said container body comprises one or more relatively flexible side sleeves.

21. A container assembly comprising a container base, a collapsed container body disposed on said container base and a container lid according to any one of the preceding claims, wherein the container lid is disposed over said container base and collapsed body;
optionally, wherein said container body comprises one or more relatively rigid side panels;
alternatively, wherein said container body comprises one or more relatively flexible side sleeves.

22. A container comprising a container base, an erected container body disposed on said container base and a container lid according to claim 1, wherein the container lid is disposed on said erected container body;
optionally, wherein said container body comprises one or more relatively rigid side panels;
alternatively, wherein said container body comprises one or more relatively flexible side sleeves.

23. The container of claim 22, whose footprint is sized according to a standard pallet size.

24. A method of drying a lid according to claim 1, the method comprising spinning the container lid or a container assembly including the container lid around said axis.

25. A method of drying a lid according to claim 24, wherein the method comprises disposing the lid with the lid underside facing down; or, retaining the container body in a predetermined position inside the container assembly; or, balancing a rotor of a spin dryer.
